(19) United States
(12) Patent Application Publication
(10) Pub. No.: US 2007/0289974 A1
(43) Pub. Date: Dec. 20, 2007

(54) CRYOGENIC INSULATION SYSTEMS WITH NANOPOROUS COMPONENTS

(75) Inventors: Christopher Blair, Littleton, CO (US); Mario Saba, Montreal (CA); George L. Gould, Mendon, MA (US); Duan Li Ou, Northborough, MA (US)

Correspondence Address: ASPEN AEROGELS INC.;IP DEPARTMENT, 30 FORBES ROAD, BLDG. B, NORTHBOROUGH, MA, 01532, US

(73) Assignee: ASPEN AEROGELS, INC., Northborough, MA (US)

(21) Appl. No.: 11/538,685

(22) Filed: Oct. 4, 2006

Related U.S. Application Data
(60) Provisional application No. 60/723,399, filed on Oct. 4, 2005.
(60) Provisional application No. 60/730,987, filed on Oct. 28, 2005.

(51) Int. Cl. F17C 1/12

(52) U.S. Cl. 220/560.15

(57) ABSTRACT

Embodiments of the present invention describe an insulation system comprising: a primary shell; a secondary shell positioned to cover at least a portion of the primary shell; a cryogenic fluid contained by the primary shell and at least one load-bearing primary insulation component disposed between the secondary shell and the primary shell. Optionally an intermediary shell is placed between the primary shell and the secondary shell along with a secondary insulation component resulting in a shell/insulation/shell/insulation/shell arrangement. In either arrangement, the primary, secondary or both insulation components comprise a material with a nanoporous aerogel optionally reinforced with a fibrous element.

### CROSS-REFERENCES TO RELATED APPLICATIONS

This application claims benefit of priority to U.S. Provisional Patent Application Ser. No. 60/723,399 filed on Oct. 4, 2005 and 60/730,987 filed on Oct. 28, 2005; the contents of all of the above are hereby incorporated by reference as if fully set forth.

### FIELD OF INVENTION

Embodiments of the present invention relate to cryogenic technology; in particular, to handling and storage of cryogenic fluids such as, but not limited to Liquid Natural Gas (LNG), Liquid Petroleum Gas (LPG) and the like.

### BACKGROUND

Storage and transportation of naturally gaseous compounds can be facilitated by liquefaction (via cooling) whereby the volume of the compound is reduced dramatically. For instance, liquefaction, of natural gas (a mixture of hydrocarbons, typically 65-95% methane and small amounts of ethane, propane and butane) can reduce the overall volume by a factor of 600. However, this requires an insulation system for maintaining extremely cold temperatures, typically less than about −160° C., within the cryogenic fluid container. Furthermore, transportation (such as with LNG transport vessels) can call for added mechanical performance from such systems. Aerogels are good candidates for cryogenic insulation and thus far have been suggested for use with limitations.

In disclosures such as U.S. Pat. Nos. 3,948,409 (Ovchinnikov et al.) and 3,114,469 (Francis et al.), insulation materials are not ideal for installation in all cryogenic structures and do not furnish any mechanical integrity to the overall system. In US patent application 2005/0016198A1 (Wowk et al.) cryogenic insulation but without any characterization of dimensional, chemical, or mechanical attributes thereof. In yet another disclosure, U.S. Pat. No. 5,386,706 (Bergsten et al.) suggests using aerogels. The published US patent application 2003/0203149A1 suggests hollow microspheres Finally published US patent application 2003/0029877A1 describes insulation without any mechanical characterization thereof. This type of system has a limited applicability and may not be suitable for large cryogenic systems such as LNG cargo containment systems.

### SUMMARY OF THE INVENTION

Embodiments of the present invention describe an insulation system comprising: a primary shell; a secondary shell positioned to cover at least a portion of the primary shell; a cryogenic fluid contained by the primary shell and at least one load-bearing primary insulation component disposed between the secondary shell and the primary shell. Optionally an intermediary shell is placed between the primary shell and the secondary shell along with a secondary insulation component resulting in a shell/insulation/shell/insulation/shell arrangement. In either arrangement, the primary, secondary or both insulation components comprise a material with a continuous and nanoporous structure reinforced with a fibrous element.

Insulation systems and method of handling, storing and transporting cryogenic fluids are described and such system include a primary shell having an interior and an exterior surface; a secondary shell having an interior and an exterior surface and positioned such that at least a portion of said exterior surface of the primary shell is covered by the secondary shell; a cryogenic fluid in contact with the interior surface of the primary shell and at least one primary insulation component disposed between the secondary shell and the primary shell, said insulation component comprising a nanoporous aerogel material are described. The system and accompanying methods may further comprise an intermediary shell having an interior and exterior surface placed between the primary shell and the secondary shell and a secondary insulation component disposed between intermediary shell and the secondary shell, optionally such secondary insulation comprises a nanoporous aerogel. The aerogel material is in a blanket form, may be reinforced with fibers, fiber battings, fibrous mat, lofty fiber battings or combinations thereof. The aerogel material may comprise an inorganic or organic material and may specifically include chitosan, polymethyl methacrylate, a member of the acrylate family of oligomers, trialkoxysilylterminated polydimethylsiloxane, polyoxyalkylene, polyurethane, polybutadiene, a member of the polyether family of materials or inorganic material such as silica, titania, zirconia, alumina, hafnia, yttria, ceria, nitrides, carbides or combinations thereof.

The aerogel materials may also include an opacifier; preferably an infrared opacifier such as B₄C, Diatomite, Manganese ferrite, MnO, NiO, SnO, Ag₂O, Bi₂O₃, TiC, WC, carbon black, titanium oxide, iron titanium oxide, zirconium silicate, zirconium oxide, iron (I) oxide, iron (III) oxide, manganese dioxide, iron titanium oxide (ilmenite), chromium oxide, silicon carbide, or mixtures thereof. The aerogel materials comprises aerogel particles

The insulation components may be at reduced pressures; such as between about 759 torr and about 1×10⁻³ torr and preferably between 759 torr and 10 torr. The aerogel material may be capable of maintaining an acceptable thermal conductivity value after exposure to at least a compressive load of 100 psi.

The insulation components may further comprise a foam material. Foam materials that can be used may include, but not limited to foams comprising polyurethane, polyvinylchloride, polyimide, polyethylene, polypropylene, polystyrene. Optionally syntactic foams may also be used.

The insulation components comprises a metallic or polymer-metal layer. The metallic layer may be an aluminum, steel, invar, reinforced polymer, bonded polymer (such as but not limited to Triplex), or stainless steel layer. The systems and methods further provide for measuring or monitoring gaseous species within said system. It may further provide for measuring or monitoring the temperatures within different regions of said system. It may further provide system sand methods wherein gaseous species or temperature may be controlled by manipulation of other variables in the manufacture, installation or operation of cryogenic fluid systems. Cryogenic fluid as used herein may refer to any fluid at low temperatures. In a preferred embodiment, they are cryogenic fluid is selected from the group comprising: liquefied natural gas, liquefied petroleum gas, liquid nitrogen, liquid hydrogen, liquid oxygen and any combination thereof.

The systems and methods further include at least a layer of aluminum layer, at least a layer of glass cloth or combinations thereof. The primary shell, secondary shell, or both provided include Invar®, stainless steel, Duplex stainless steel or aluminum. The aerogel material may be enclosed in a container such as polymeric film, a non-woven fabric, woven fabric, metallic film, foam material layer, wooden components, plywood panels and combinations thereof.

### DETAILED DESCRIPTION

The cryogenic insulation systems described in embodiments of the present invention comprise a primary and a secondary shell with a primary insulation component disposed there between. The insulation components can be constructed to be load-bearing. Optionally an intermediary shell is placed between the primary shell and the secondary shell along with a secondary insulation component resulting in a shell/insulation/shell/insulation/shell arrangement. In either arrangement, the primary, secondary or both insulation components comprise a material with a continuous and nanoporous structure reinforced with a fibrous element.

As used herein, “shell” indicates a shaped material. Examples of such shapes include but are not limited to: flat, spherical, hemispherical, cylindrical, hemi cylindrical, half-pipe, annular, helical, navicular, corrugated, grooved, rippled, and various others. Furthermore, a “shell” as used herein can be a one-piece structure or be derived from at least two butted pieces. Such pieces may be of any shape such as flat, curved, textured or any of the above said shapes which when combined together ultimately result in flat, spherical, hemispherical, cylindrical, hemi cylindrical, half-pipe, annular, helical, navicular, corrugated, grooved or rippled shapes. Furthermore, a “shell” as used herein is not limited to any particular type of material.

In dealing with cryogenic fluids and large temperature differentials, materials with low thermal expansion coefficients may be desirable since for example, a double hull (i.e. shell) of a ship may experience a temperature gradient with −163° C. on one side (cryogenic fluid) and ambient temperature 20-40° C. on the other side. Therefore materials with low thermal expansion coefficients such as 10⁻⁶ K⁻¹ or better are useful. However materials with thermal expansion coefficients larger than 10⁻⁶ K⁻¹ may be modified in form to accommodate for expansion and contraction of the material. One example involves creating a corrugated, rippled or grooved sheet of material where the shape of the material aids expansion and contraction of the same. Therefore, materials such as stainless steel, duplex stainless steel, aluminum, Invar®, and others that exhibit low thermal expansion coefficient or that can be formed into shapes (or both) which accommodate for thermal expansion and contraction, are useful for the present embodiments. Alternatively, reinforced plastics or polymers or composite aluminum glass fiber such as Triplex may also be used in primary or secondary shell construction.

The insulation components of the embodiments of the present invention can be constructed to be load-bearing. As utilized herein, the term “load-bearing” refers to structures that can at least partially bear loads transmitted by the primary, secondary or intermediary shell of said insulation system while not sustaining a degree of damage to the microstructure that would result in thermal conductivities outside of an acceptable percentage increase. An acceptable increase in thermal conductivity for aerogel blankets is for example, less than about 80% or less than about 70% or less than about 60% or less than about 50% or less than about 40% under compressive loads. The compressive loads may for example originate from the weight of the stored cryogenic fluid.

In an embodiment, aerogel blankets are flexible enough to conform to the surface they are insulated with. Flexible as used herein refers to the materials ability to be bent around objects without visible cracks.

There are several ways of constructing such load bearing insulation components. In one instance, the insulation component can comprise a high performance insulation (e.g. aerogel blankets and/or aerogel particles/beads) contained in an outer casing (hard plastic, plywood, composite, foam, etc.) which essentially provides all of the mechanical integrity of the insulation component. Alternatively the high performance insulation (e.g. aerogel blankets and/or aerogel particles/beads) can be sandwiched between or embedded within rigid or flexible foam panels (e.g. foams of polyurethane, polyvinylchloride, polyimide, polyethylene, polypropylene, polystyrene, syntactic foams.) Of course, other foam panels such as those based on polyurethane, polyimide polyvinylchloride or polystyrene may also be used. This can be achieved with or without an additional binding composition such as, but not limited to, an acrylic polymer. In another configuration, the high performance insulation (e.g. aerogel blankets) can at least partially share the loads with their outer casing (a rigid or flexible material) or a panel attached thereto (with a binder composition.)

The presently described insulation components derive at least a portion of their thermal insulating capability from nanoporous materials. “nanoporous” within the context of the present description refers in general to materials with average pore sizes mostly in the nanometer range, preferably below 100 nanometers and most preferably below 50 nm In a specific sense, “nanoporous” refers to a group of materials comprising aerogel and xerogel materials. Furthermore, within the context of embodiments of the present invention “aerogels” or “aerogel materials”, refer to “gels containing air as a dispersion medium” in a broad sense and include, xerogels and cryogels in a narrow sense.

As used herein, “aerogel” refers to a unique class of ultra size, low density, and primarily open-cell materials. Aerogels are a class of materials generally formed by removing a mobile interstitial solvent phase from the pores of a gel structure supported by an open-celled polymeric material at a temperature and pressure above the solvent critical point. By keeping the solvent phase above the critical pressure and temperature during the entire solvent extraction process, strong capillary forces generated by liquid evaporation from very small pores that can cause shrinkage and pore collapse are not realized. Aerogels typically have low bulk densities (about 0.15 g/cc or less, preferably about 0.03 to 0.3 g/cc), very high surface areas (generally from about 400 to 1,000 m²/g and higher, preferably about 700 to 1000 m²/g), high porosity (about 95% and greater, preferably greater than about 97%), and relatively large pore volume (more than about 3.8 mL/g, preferably about 3.9 mL/g and higher). The combination of these properties in an amorphous structure gives the lowest thermal conductivity values (9 to 16 mW/mK at 37° C. and 1 atmosphere of pressure) for any coherent solid material.

Aerogels have continuous porosity and a microstructure composed of interconnected colloidal-like particles or polymeric chains with characteristic diameters of 100 angstroms. These microstructures impart the high surface areas to aerogels. Their ultra fine cell/pore size minimizes light scattering in the visible spectrum, and thus, aerogels can be prepared as transparent, porous solids. Further, the high porosity of aerogels makes them excellent insulators with their thermal conductivity being about 100 times lower than that of the prior known fully dense matrix foams. Still further, the aerogel skeleton provides for the low sound velocities observed in aerogels.

Aerogels may be in a “wet-gel” form in which the aerogel matrix retains fluid such as a solvent phase, but more preferably aerogels are in a dried form, such as that produced by ambient pressure drying or supercritical extraction. Specifically, and as used herein, an aerogel has a dried form for which: (1) the average pore diameter is between about 2 nm and about 50 nm, which may be determined from the multipoint BJH (Barrett, Joyner and Halenda) adsorption curve of N₂ over a range of relative pressures, typically 0.01-0.99 (“the BJH method” measures the average pore diameter of those pores having diameters between 1 and 300 nm and does not account for larger pores); and (2) at least 50% of its total pore volume comprises pores having a pore diameter of between 1 and 300 nm. The size of the particles and the pores of an aerogel typically range from about 1 to about 100 nm.

Aerogels of various compositions are known, for example inorganic aerogels (such as silicon aerogels), organic aerogels (such as carbon aerogels) and inorganic/organic hybrids (see N. Hüsing and U Schubert (1998) Angew. Chem. Int. Ed. 37: 22-45). Inorganic aerogels are generally based upon metal alkoxides and include materials such as silica, carbides, and alumina. Inorganic aerogels, for example, silica, alumina, or zirconia aerogels, are traditionally made via the hydrolysis and condensation of metal alkoxides, such as tetramethoxy silane or via gelation of silicic acid or of water glass. Organic aerogels include, but are not limited to, urethane aerogels, resorcinol formaldehyde aerogels(RF), polyolefin aerogels, melamine-formaldehyde aerogels, phenol-furfural aerogels and polyimide aerogels. Most of the aerogels may be carbonized using typical processes available. Organic aerogels, such as RF aerogels, are typically made from the sol-gel polymerization of resorcinol or melamine with formaldehyde under alkaline conditions. Each type of aerogel, inorganic or organic, involves the formation of a gel, and drying of the gel by either air drying, other forms of subcritical fluid extraction, or supercritical extraction. The final composition of the aerogel is determined by the processing of the gel, which may produce a xerogel, an aerogel, or a hybrid xerogeVaerogel. Following the drying operation of the organic gels, for example, the aerogel may be pyrolyzed to produce a carbon aerogel.

Aerogels can also be classified by their bulk properties. Monolithic aerogels may be considered one class of aerogels, as opposed to beads, particles, powders, and putties. Thin film and sheet aerogels can be defined as a coating, less than 5 mm thick, formed on a substrate. Granular or powder aerogels can be defined as comprising particle sizes of having volumes less than 0.125 mL. In general, aerogels that can be made in monolithic form have advantages over thin film or granular aerogels. For example, monolithic aerogels can be made for a wide variety of applications in which thin films, sheets or granulars would not be practical. For example, most thermal insulation, acoustical attenuation and kinetic (shock absorption) applications require thicker insulating material that cannot be provided by thin films or sheets. And, granular materials tend to settle and are not mechanically stable. Many chemical and catalytic applications also require more material than can be provided by thin films or sheets. Even some electrical applications require monolithic materials such as fuel cells and large capacitor electrodes.

Low-density aerogel materials (0.01-0.3 g/cm³) are widely considered to be the best solid thermal insulators, better than the best rigid foams with thermal conductivities of 10 mW/mK and below at 100° F. and atmospheric pressure. Aerogels function as thermal insulators primarily by minimizing conduction (low density, tortuous path for heat transfer through the solid nanostructure), convection (very small pore sizes minimize convection), and radiation (IR absorbing or scattering dopants are readily dispersed throughout the aerogel matrix). Depending on the formulation, they can function well at cryogenic temperatures to 550° C. and above. Aerogel materials also display many other interesting acoustic, optical, mechanical, and chemical properties that make them abundantly useful.

In an embodiment, aerogels are clearly distinguished from what is typically known in the art as microporous materials. Such materials are formed by bringing together silica and other metal oxide particles which themselves are not generally porous. However, when such particles in nanometer size are brought together, they form pores in between such particles. Such pores are typically above 100 nm and their average pore size is definitely more than 100 nm.

Furthermore, the chemical composition thereof can be based on a metal oxide, organic compound (e.g. polymer) or both (hybrid organic-inorganic). Still further, they can be opacified with compounds such as but not limited to: B₄C, Diatomite, Manganese ferrite, MnO, NiO, SnO, Ag₂O, Bi₂O₃, TiC, WC, carbon black, titanium oxide, iron titanium oxide, zirconium silicate, zirconium oxide, iron (I) oxide, iron (III) oxide, manganese dioxide, iron titanium oxide (ilmenite), chromium oxide, silicon carbide or mixtures thereof. Also as used herein “aerogel blankets” or “blankets” refer to aerogel or aerogel materials that are substantially in a blanket form. This may involve fiber reinforcement. Such fiber reinforcement may be of many type. Individual chopped fiber or microfibers may be added to the aerogel matrix, or such fibers may help aerogel beads stay together in blanket form or a fiber matrix may be formed similar to a batting or felt within which the aerogel matrix may coexist. Some examples of fiber reinforced aerogels are found in US Patent Publication No. 20020094426; U.S. Pat. No. 5,789,075; U.S. Pat. No. 5,306,555; U.S. Pat. No. 6,770,584; U.S. Pat. No. 6,479,416; U.S. Pat. No. 6,083,619; and U.S. Pat. No. 6,080,475.

In yet another embodiment of the present invention, such aerogel materials may be flexible. Flexible as used herein may be interpreted in several ways depending on the end use application need. When insulating complex corners in various embodiments of the present invention, flexible aerogel materials are such that they conform to such complex shapes without substantially break into unusable pieces. Some microscopic cracks may develop in such insulation if bent, and such cracks are allowable within the context of flexible aerogels.

In another embodiment of the present invention, fiber reinforced aerogel material has aerogel in substantially continuous form through said fibers. In other words, such aerogel materials are obtained from their liquid precursors by removal of solvent such that it retains the continuous aerogel. Discrete aerogel particles or any structure made using such particles are excluded from the continuous fiber reinforced aerogels of this particular embodiment.

They can be fiber-reinforced with fibers that are polymer-based (e.g. polyester), inorganic-based (e.g. carbon, Polyacrylonitrile [PAN], O-PAN, quartz, etc.) or both, in forms such as: a batting (fibrous or lofty), fibrous mats, felts, microfibers, chopped fibers, woven fabrics, unwoven fabrics or a combination thereof.

Examples of metal oxide-based aerogels include, but are not limited to silica, titania, zirconia, alumina, hafnia, yttria and ceria. The organic forms can be based on, but are not limited to, compounds such as, urethanes, resorcinol formaldehydes, polyimide, polyacrylates, chitosan, polymethyl methacrylate, members of the acrylate family of oligomers, trialkoxysilylterminated polydimethylsiloxane, polyoxyalkylene, polyurethane, polybutadiane, a member of the polyether family of materials or combinations thereof. Examples of organic-inorganic hybrid aerogels are, but not limited to, silica-PMMA, silica-chitosan, silica-polyether or possibly a combination of the aforementioned organic and inorganic compounds. The published US patent applications 2005/0192367 and 2005/0192366 teach a whole host of such hybrid organic-inorganic aerogel materials along with their blanket forms useful in embodiments of the present invention.

In one embodiment the primary shell comprises a stainless steel sheet, preferably in a corrugated form. The secondary shell comprises a multi-ply structure comprising two sheets of a fibrous material, such as glass cloth, and a sheet of a metal, such as an aluminum foil, disposed there between. Optionally the metal sheet is bonded to the two sheets of fibrous material via an adhesive. The primary insulation component comprises aerogel blankets which can be obtained from Aspen Aerogels Inc. Aerogel blankets based on organic, inorganic, or hybrid organic-inorganic aerogels can be used. Optionally the aerogel blankets are adhered to a panel constructed from polyurethane foam or wood in forms such as plywood or solid wood. Also optionally the region about the primary insulation component is continuously or intermittently flushed with nitrogen or argon gas. As an alternative, the region about the primary insulation component is flushed with nitrogen or argon gas and sealed. Also optional, is a sensor placed near the primary insulation component to monitor gaseous species (e.g. hydrocarbons) concentration. Further optional, a sensor is placed near the primary insulation component to monitor the temperature thereabout.

In another embodiment, aerogel based insulation may be secured in a gas impermeable envelope and placed in various places such as between primary and secondary shell or between primary and intermediate shell or between intermediate and secondary shell. Such envelope may further be hermetically sealed. Aerogel based insulation mat be an aerogel blanket and preferably a flexible aerogel blanket.

In another embodiment, gases such as nitrogen, helium, argon or other less reactive gases may be present in the envelope in which aerogel based insulation is present. Such gases may be present at pressures below, above or at atmospheric pressure. Thermal conductivity of reduced pressure systems may be even higher at much lower pressures.

In another embodiment, aerogels or aerogel based materials used in many other embodiments may be strengthened such that when such aerogels are dried after exposure to a liquid, the structural strength is sufficient to resist compressive forces so that the aerogel or aerogel based material dimensions are sufficiently retained. Such retention may also be demonstrated by no substantial degradation of thermal performance.

In yet another embodiment of the present invention, the density of the aerogels or aerogel based materials may be increased or alternatively the solid structure of the aerogel may comprise hybrid materials, organic polymers, other reinforcements, conformal coatings or combinations thereof.

In yet another embodiment of the present invention, aerogels may have pore size distribution such that the distribution is shifted to the right a little compared to conventional aerogels. More larger pores (i.e. pores below 100 nm and still larger than 10 nm or so pores present in conventional aerogels) reduce the capillary forces that may shrink the aerogel dimensions during drying or an equivalent event. Control of pore size or pore size distribution may be accomplished through several factors including controlling solgel chemistry, processing conditions, introduction of other materials and others. Such controlling mechanisms are known in the art and the reader may be directed to R. K. Iler, Colloid Chemistry of Silica and Silicates, 1954; R. K. Iler, The Chemistry of Silica, 1979, C. J. Brinker and G. W. Scherer, Sol-Gel Science, 1990, for more detailed explanation on such topics.

In yet another embodiment of the present invention, aerogel materials involved in various other embodiments may be manufactured such that they are relatively both hydrophobic and oleophobic. Various techniques may be employed to achieve such aerogels including use of fluorocarbon residues in aerogel structures. Alternatively, surface tension of the aerogels may be reduced by incorporating alternative surface tension reducing components.

In yet another embodiment of the present invention, various cross linked aerogels may be used to make the aerogel structures of various embodiments. Cross linked aerogels such as the ones described in Meador et al. Chem. Mater. 2005, 17, 1085-1098, Katti, et al. Chem. Mater. 2006, 18, 285-296 are non-limiting examples of cross linked aerogels applicable to this embodiment. These may provide for a high compression resistance and even may enable reducing some structural components from various other embodiments.

In yet another embodiment of the present invention, foam components such as polyurethane, polyethylene, polypropylene, polyimide, polystyrene may be combined with aerogels or fiber reinforced aerogels of several embodiments of the present invention. Additionally, syntactic foams may be combined with aerogels or fiber reinforced aerogels. Such combinations could be after the aerogels are made or may be part of the process of making the aerogel based material itself. Foams or syntactic foams may provide further compression resistance and may protect aerogel materials from any undue compression forces. Syntactic foams are composite materials synthesized by filling a metal, polymer or ceramic matrix with hollow particles.

In another embodiment, the secondary shell is constructed from a metal such as a steel alloy (e.g. Invar®) and an intermediary shell is situated between the primary shell and the secondary shell. Optionally, a secondary insulation component is located between the secondary shell and the intermediary shell resulting in a shell/insulation/shell/insulation/shell arrangement. Here the intermediary shell comprises a multi-ply structure comprising two sheets of a fibrous material, such as glass cloth and a sheet of a metal, such as aluminum foil, disposed there between. Optionally, the metal sheet is bonded to the two sheets of fibrous material via an adhesive. The secondary insulation component comprises aerogel blankets which can be obtained from Aspen Aerogels Inc. Aerogel blankets based on organic, inorganic, or hybrid organic-inorganic aerogels can be used. Optionally the aerogel blankets can be attached to or covered by or encased in a panel constructed from polyurethane foam or wood (e.g. plywood.) As an alternative, the secondary insulation component can comprise a polyurethane foam panel instead of an aerogel blanket. Optionally the region about at least one insulation component is continuously or intermittently flushed with nitrogen or argon gas. As an alternative, the region about at least one insulation component is flushed with nitrogen or argon gas and sealed. Also optional, is a sensor placed near at least one insulation component to monitor gaseous species (e.g. hydrocarbons) concentration. Further optional, a sensor is placed near at least one insulation component to monitor the temperature thereabout

In one embodiment the primary and secondary shell comprise a steel alloy, preferably a sheet of Invar®. The primary insulation component comprises aerogel blankets which can be obtained from Aspen Aerogels Inc. Aerogel blankets based on organic, inorganic, or hybrid organic-inorganic aerogels can be used. Optionally the aerogel blankets are adhered to a panel constructed from polyurethane foam or wood in forms such as plywood or solid wood. Alternatively the aerogel blankets are encased in a box constructed from plywood. Optionally the region about the primary insulation component is continuously or intermittently flushed with nitrogen or argon gas. As an alternative, the region about the primary insulation component is flushed with nitrogen or argon gas and sealed. Also optional, a sensor can be inserted into or placed adjacent to at least one insulation component to monitor gaseous species (e.g. hydrocarbons) concentration. Further optional, a sensor can be inserted or placed adjacent to or within at least one insulation component to monitor the temperature thereabout.

In another embodiment, an intermediary shell is situated between the primary shell and the secondary shell. Optionally, a secondary insulation component is located between the secondary shell and the intermediary shell resulting in a shell/insulation/shell/insulation/shell arrangement. Here the intermediary shell is a sheet of low thermal conductivity steel alloy such as Invar®. The secondary insulation component comprises aerogel beads, particles, and aerogel blankets. One such aerogel blanket may be available from Aspen Aerogels Inc. Aerogel blankets based on organic, inorganic, or hybrid organic-inorganic aerogels can be used. Optionally the aerogel blankets can be attached to or covered by or encased in a panel constructed from polyurethane foam or wood (e.g. plywood.) Optionally aerogel beads such as hybrid organic-inorganic aerogels such as silica-PMMA, silica-chitosan blend and others as described in US patent publications 2005/0192367 and 2005/0192366 can be used. Alternatively, hybrid aerogel beads in combination with silica aerogel beads can be used in any ratio between about 1% to about 99%. Optionally the aerogel beads can be attached to or encased in a panel constructed from polyurethane foam or wood (e.g. plywood.) Optionally the aerogel beads are within a fibrous matrix (e.g. carbon felt, quartz batting, polyester batting or similar structures), or individually fiber reinforced. Alternatively to the aerogel/panel combination, only a polyurethane foam panel can be used as the secondary insulation component (where the primary insulation component comprises an aerogel blanket.) Optionally the region about at least one insulation component is continuously or intermittently flushed with nitrogen or argon gas. As an alternative, the region about at least one insulation component is flushed with nitrogen or argon gas and sealed. Also optional, a sensor can be inserted into or placed adjacent to at least one insulation component to monitor gaseous species concentration. Further optional, a sensor can be inserted or placed adjacent to at least one insulation component to monitor the temperature thereabout.

In some embodiments silica/PMMA hybrid aerogel blankets are used wherein their flexural strength is greater that 100 psi. Such blankets also typically exhibit less than about 10% (or less than about 8%, or less than about 6%) deformation under uniaxial compression of about 17.5 psi and up to about 98% (or up to about 90%, or up to about 85%) recovery strain after uniaxial compression of about 4000 psi. The density for such composites is typically between about 0.05 g/cm³ to about 0.25 g/cm³ with a thermal conductivity between about 12 to about 18 mW/mK.

In some embodiments silica/PMMA hybrid aerogel beads are placed in a binder matrix (such as methacrylates.) As a non-limiting example, such composites with a 0.15 g/cm³ density can recover about 99% of compressive strain after a 250 psi load, or recover about 93% of compressive strain after a 1500 psi load. The thermal conductivity is about 21.9 mW/m.K without a load and 25.2 mW/mK while under a 250 psi load.

In some embodiments silica aerogel blankets are employed. Such blankets can be staked up in a multiple ply form such that under extreme compressive loads, the R value of the overall system is still within a desirable range. The density of the silica aerogel blankets are between about 0.03 g/cm³ to about 0.3 g/cm³ or between about 0.08 g/cm³ to about 0.25 g/cm³.

In one embodiment, percent increase in density of aerogel blankets after compression is less than about 1000% or less than about 900% or less than about 800% or less than about 700% or less than about 600% or less than about 500% or less than about 400% or less than about 300% or less than about 200% or less than about 100% or less than about 50%.

In another embodiment, the aerogel blankets and/or aerogel beads or particles are maintained at reduced pressures (i.e. below atmospheric pressure or 760 torr.) More typically, reduced pressures in between about 759 torr and about 1×10⁻³ torr are used. Preferred pressures are between 759 torr and 10 torr and most preferred are between 759 torr and 75 torr. This can be achieved by sealing an aerogel blankets in a relatively gas impermeable membrane after applying a vacuum therein. The membrane can be a flexible polymeric film or a metallized polymeric film (e.g. Mylar®) and heat sealed to retain reduced pressures therein. Another example involves placing the aerogel blankets in a reduced pressure environment of an annular space of a pipe-in-pipe system. In an embodiment, it is sufficient if the aerogel material or other insulation componenets is at least exposed to any reduced pressure at some time during manufacture, installation or operation of associated systems.

In another embodiment, the aerogel beads or particles are maintained at reduced pressures (i.e. below 760 torr.) More typically, reduced pressures in between about 759 torr and about 1×10⁻³ torr are used. This can be achieved by sealing an aerogel material (e.g. beads) in a relatively gas impermeable membrane after applying a vacuum therein. The membrane can be a flexible polymeric film or a metallized polymeric film (e.g. Mylar®) and heat sealed to retain reduced pressures therein. Another example involves the aerogels in a reduced pressure environment in an annular space of a pipe-in-pipe system.

In at least some embodiments, aerogel beads of various diameters are utilized. Generally, beads of about 0.1 μm in diameter or larger can be used. In one instance, beads with diameters larger than about 0.5 mm or larger than about 1.0 mm are used. In some instances, the beads can have diameters as large as about 2 cm.

In another embodiment, beads with diameters of varying ranges are used such that the smaller diameter beads occupy the interstitial positions between the larger beads. This allows better packing of the aerogel beads and can consequently reduce convective heat transfer in the insulation structure.

In yet another embodiment, a combination the aerogel beads with varying compositions is used. This arrangement can have aerogel beads with compositions having hybrid organic-inorganic, organic, inorganic, opacified, unopacified, fiber-reinforced, coated or any combination thereof in any ratio. As a non-limiting example, silica aerogel beads in combination with silica-PMMA hybrid aerogel beads are used.

In one embodiment, silica aerogel beads are only used. In another embodiment only silica-PMMA hybrid aerogel beads are used.

In at least some embodiments, aerogel blankets are combined with aerogels of different forms such as: random pieces, beads, bubbles in various sizes and in any combination. Generally, particles of about 0.1 μm in diameter or larger can be used. In one instance, particles with diameters larger than about 0.5 mm or larger than about 1.0 mm are used. In some instances, the particles can have diameters as large as about 2 cm. In some cases, particles of varying ranges are used such that the smaller particles occupy the interstitial positions between the larger particles. This allows for better packing and can consequently reduce convective heat transfer in an insulation structure. The particles can of course be organic, inorganic, hybrid organic-inorganic or a combination thereof with or without opacification.

In at least some embodiments more than one ply of aerogel blankets can be used. Such multi-ply structures may or may not be fastened. Fastening means include but are not limited to posts, rivets, stitches, tags, z-aligned fibers (i.e via needle punching), adhesives, staples and a variety of others.

In one embodiment the secondary shell comprises concrete or reinforced concrete. A concrete ballast for example can provide additional weight, safety and mechanical stability to the overall cryogenic system. For example in maritime vessels, concrete can help achieve the desired level of buoyancy. For land-based containers, a concrete shell can provide added safety and mechanical stability.

In one embodiment, the aerogel blankets or aerogel beads/particles are in a gaseous environment comprising nitrogen, argon, oxygen, hydrogen, or any combination thereof.

In one embodiment silica aerogel blankets or aerogel beads/particles encased in a plywood box are used as the primary and/or secondary insulation component. At least one insulation component designed as such is capable of withstanding at least about a 180 psi compressive pressure without any fracture of the box or the silica aerogel blanket. Such mechanical performance may be achieved via appropriate thickness and/or geometric design of the box.

In another embodiment, aerogel blankets or aerogel beads/particles are enclosed or embedded within a flexible container. As a non-limiting example the container may be a woven fabric, non-woven fabric, metallic sheet, metallized polymeric membrane, polymeric membrane, or a combination of the preceding. In one example, the aerogel blanket is encased in a tough fabric, where the structure overall is still capable of changing shape to accommodate the contours of a neighboring structure and the aerogel blanket is protected from abrasion. In another example, the blanket is sealed in a flexible polymeric film such as Tyvek®. As another example the blanket is placed in the container along with particulate aerogels or another insulating material such as polyurethane. In another example the aerogel blanket is encased in a hard plastic material such as HDPE, PVA, PVC and the like or a rubber material.

In another embodiment the insulation systems presently described are installed in a maritime vessel for transport of cryogenic fluids such as liquid oxygen, liquid nitrogen, liquid hydrogen, liquid helium, liquid argon, LNG and LPG.

In another embodiment, the insulation systems of the present invention provide acoustic insulation derived at least in part from aerogel blankets or aerogel beads/particles. Accordingly, aerogel blankets or aerogel beads/particles can be utilized for thermal and acoustic insulation benefits. Depending on frequency range of interest, aerogel blankets or aerogel beads/particles can exhibit good acoustic absorbance, reflectance, transmittance or a combination thereof. For instance, acoustic absorption within at least some frequency ranges within the communication range can be achieved with aerogel blankets. Furthermore, enclosure or combination of the aerogel blankets or aerogel beads/particles with another acoustically insulating material can enhance such properties. Said acoustically insulating material may be in the form of a film, foam, fibrous layer (woven, non-woven, mat or batting) or a combination thereof and comprise polyether, cotton, polyurethane, vinyl, polypropylene, polyimide, polyvinyl chloride, polystyrene, polyester or any combination thereof.

We claim:

1. An insulation system comprising:
a primary shell having an interior and an exterior surface;
a secondary shell having an interior and an exterior surface and positioned such that at least a portion of said exterior surface of the primary shell is covered by the secondary shell; and
at least one primary insulation component disposed between the secondary shell and the primary shell, said insulation component comprising a nanoporous aerogel material, wherein, the interior surface of the primary shell is capable of being in contact with a cryogenic fluid.

2. The system of claim 1 further comprising an intermediary shell having an interior and exterior surface placed between the primary shell and the secondary shell and a secondary insulation component disposed between intermediary shell and the secondary shell, optionally such secondary insulation comprises a nanoporous aerogel.

3. The system of claim 1 wherein aerogel material is in a blanket form.

4. The system of claim 1 wherein aerogel material is reinforced with fibers, fiber battings, fibrous mat, lofty fiber battings or combinations thereof.

5. The system of claim 1 wherein said aerogel material comprises an inorganic material.

6. The system of claim 1 wherein the aerogel material comprises an organic material.

7. The system of claim 1 wherein said aerogel material comprises at least one opacifying component.

8. The system of claim 6 wherein said aerogel material comprises chitosan, polymethyl methacrylate, a member of the acrylate family of oligomers, trialkoxysilylterminated polydimethylsiloxane, polyoxyalkylene, polyurethane, polybutadiene, a member of the polyether family of materials or combinations thereof.

9. The system of claim 5 wherein the aerogel material comprises silica, titania, zirconia, alumina, hafnia, yttria, ceria, nitrides, carbides or combinations thereof.

10. The system of claim 7 wherein the opacifying compound is B₄C, Diatomite, Manganese ferrite, MnO, NiO, SnO, Ag₂O, Bi₂O₃, TiC, WC, carbon black, titanium oxide, iron titanium oxide, zirconium silicate, zirconium oxide, iron (I) oxide, iron (III) oxide, manganese dioxide, iron titanium oxide (ilmenite), chromium oxide, silicon carbide, or mixtures thereof.

11. The system of claim 1 wherein the primary insulation component is at reduced pressures.

12. The system of claim 11 wherein the reduced pressures are between about 759 torr and about 1×10⁻³ torr and preferably between 759 torr and 10 torr.

13. The system of claim 1 wherein the aerogel material comprises aerogel particles

14. The system of claim 1 wherein the aerogel material is capable of maintaining an acceptable thermal conductivity value after exposure to at least a compressive load of 100 psi.

15. The system of claim 1 wherein the primary insulation component further comprises a foam material.

16. The system of claim 15 wherein the foam material is selected from the group consisting of polyurethane, polyvinylchloride, polyimide, polyethylene, polypropylene, polystyrene, syntactic foams or combinations thereof.

17. The system of claim 2 wherein the primary insulation component comprises a metallic or polymer-metal layer.

18. The system of claim 17 wherein the metallic layer is an aluminum layer.

19. The system of claim 1 comprising a sensor for monitoring gaseous species within said system.

20. The system of claim 1 comprising a sensor for monitoring the temperatures within different regions of said system.

21. The system of claim 1 further including at least a layer of aluminum layer, at least a layer of glass cloth or combinations thereof.

22. The system of claim 1 wherein the cryogenic fluid is selected from the group comprising: liquefied natural gas, liquefied petroleum gas, liquid nitrogen, liquid hydrogen, liquid oxygen and any combination thereof.

23. The system of claim 1 wherein the primary shell, secondary shell, or both comprise a metallic component.

24. The method of claim 23 wherein the metallic component comprises Invar®, stainless steel, Duplex stainless steel or aluminum.

25. The system of claim 1 wherein said aerogel material is enclosed in a container.

26. The system of claim 25 wherein the container comprises a polymeric film, a non-woven fabric, woven fabric, metallic film, foam material layer, wooden components, plywood panels and combinations thereof.

27. A method of handling a cryogenic fluid comprising placing or flowing said fluid in a system comprising the steps of:
Providing a primary shell having an interior and an exterior surface;
Positioning a secondary shell having an interior and an exterior surface such that at least a portion of said exterior surface of the primary shell is covered by the secondary shell;
Contacting a cryogenic fluid with the interior surface of the primary shell and Disposing at least one primary insulation component between the secondary shell and the primary shell, said insulation component comprising a nanoporous aerogel material.

28. The method of claim 27 further comprising the steps of placing an intermediary shell having an interior and exterior surface between the primary shell and the secondary shell and disposing a secondary insulation component between intermediary shell and the secondary shell; optionally such secondary insulation comprises a nanoporous aerogel material.

29. The method of claim 27 wherein said aerogel material is in a blanket form.

30. The method of claim 27 wherein said aerogel material is reinforced with fibers, fiber battings, fibrous mat, lofty fiber battings or combinations thereof.

31. The method of claim 27 wherein said aerogel material comprises an inorganic material.

32. The method of claim 27 wherein said aerogel material comprises an organic material.

33. The method of claim 27 wherein said aerogel material comprises at least one opacifying component.

34. The method of claim 32 wherein said aerogel material comprises chitosan, polymethyl methacrylate, a member of the acrylate family of oligomers, trialkoxysilylterminated polydimethylsiloxane, polyoxyalkylene, polyurethane, polybutadiene, a member of the polyether family of materials or combinations thereof.

35. The method of claim 31 wherein the aerogel material comprises silica, titania, zirconia, alumina, hafnia, yttria, ceria, nitrides, carbides or combinations thereof.

36. The method of claim 33 wherein the opacifying compound is B₄C, Diatomite, Manganese ferrite, MnO, NiO, SnO, Ag₂O, Bi₂O₃, TiC, WC, carbon black, titanium oxide, iron titanium oxide, zirconium silicate, zirconium oxide, iron (I) oxide, iron (III) oxide, manganese dioxide, iron titanium oxide (ilmenite), chromium oxide, silicon carbide, or mixtures thereof.

37. The method of claim 27 wherein the primary insulation component is at reduced pressures.

38. The method of claim 37 wherein the reduced pressures are between about 759 torr and about 1×10⁻³ torr and preferably between 759 torr and 10 torr.

39. The method of claim 27 wherein the aerogel material comprises aerogel particles.

40. The method of claim 27 wherein the aerogel material is capable of maintaining an acceptable thermal conductivity value after exposure to at least a compressive load of 100 psi.

41. The method of claim 27 wherein the primary insulation component further comprises a foam material.

42. The method of claim 41 wherein the foam material is selected from the group consisting of polyurethane, polyvinylchloride, polyimide, polyethylene, polypropylene, polystyrene, synctactic foams or combinations thereof.

43. The method of claim 27 wherein the primary insulation component comprises a metallic or polymer-metal layer.

44. The method of claim 43 wherein the metallic layer is an aluminum layer.

45. The method of claim 27 further comprising a step of measuring or monitoring gaseous species within said system.

46. The method of claim 27 further comprising a step of measuring or monitoring a temperatures within at least one region of said system.

47. The method of claim 27 further including a layer of aluminum layer between two layers of glass cloth and adhered thereto.

48. The method of claim 27 wherein the cryogenic fluid is selected from the group comprising: liquefied natural gas, liquefied petroleum gas, liquid nitrogen, liquid hydrogen, liquid oxygen and any combination thereof.

49. The method of claim 27 wherein the primary shell, secondary shell, or both comprise a metallic component.

50. The method of claim 49 wherein the metallic component comprises Invar®, stainless steel, Duplex stainless steel or aluminum.

51. The method of claim 27 wherein the aerogel material is enclosed in a container.

52. The method of claim 51 wherein the container comprises a polymeric film, a non-woven fabric, woven fabric, metallic film, foam material layer, wooden components, plywood panels and combinations thereof.
